(19) United States
(12) Patent Application Publication
(10) Pub. No.: US 2024/0054588 A1
(43) Pub. Date: Feb. 15, 2024

(54) METHOD OF A COMPETITION

(71) Applicant: Christopher John Fritz, Reno, NV (US)

(72) Inventor: Christopher John Fritz, Reno, NV (US)

(21) Appl. No.: 18/357,681

(22) Filed: Jul. 24, 2023

Related U.S. Application Data
(60) Provisional application No. 63/396,255, filed on Aug. 9, 2022.
(60) Provisional application No. 63/471,984, filed on Jun. 9, 2023.
(60) Provisional application No. 63/513,717, filed on Jul. 14, 2023.

(51) Int. Cl. G06Q 50/18; G06Q 30/0242

(52) U.S. Cl. CPC G06Q 50/184; G06Q 30/0242

(57) ABSTRACT

The embodiments herein relate generally to the method of a competition an entity administers including to: plan, operate, adapt, utilize vendor products as goods or services advertised within a business catalog, define laws, form a schedule, configure zones position on environments, display information on a medium for a witness, organize marketing for all entities, plan competition goals for results, organize consultants advising strategy for participants, organize participants competing to produce results by work towards the goals with methods and apparatus, organize feedback from evaluators producing judgements from measurements of the participants results contrasted to the goals, utilize judgements to distribute rewards, proportion awards and penalties to participants with respect to the feedback, eliminate participants according to the law, pause operations, cease operations, and if applicable award prizes acknowledging accomplishments. An entity includes participants, vendors, witnesses, advisors, and evaluators; moreover including artificial intelligence, biological life forms, and hybrids.

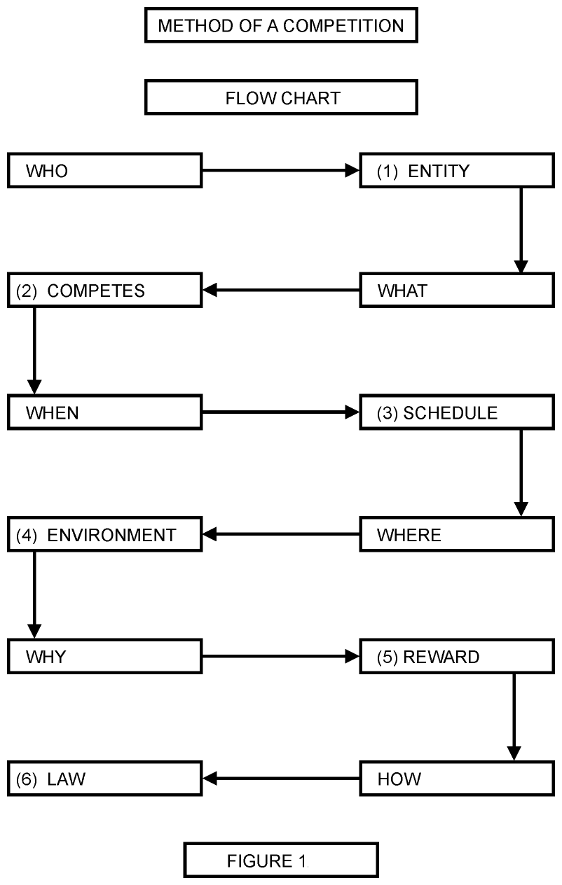

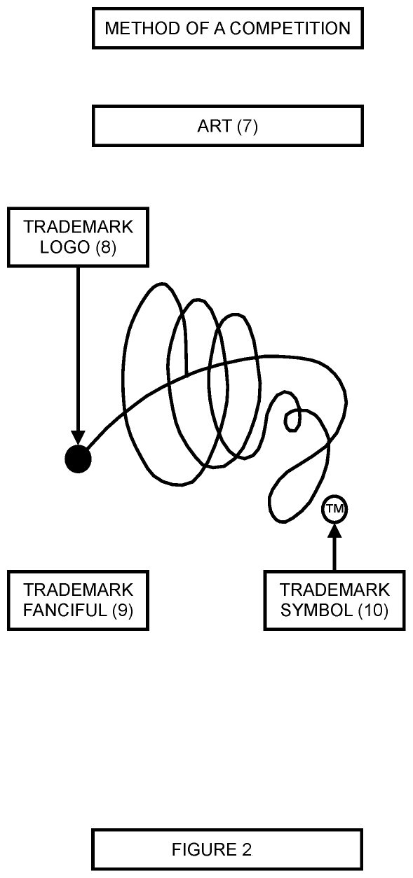

### CROSS-REFERENCE TO RELATED APPLICATIONS

This application claims priority to provisional patent application U.S. Ser. No. 63/513,717 (“The '717 application”) filed on Jul. 14 2023, provisional patent application U.S. Ser. No. 63/471,984 (“The '984 application”) filed on Jun. 9, 2023, and provisional patent application U.S. Ser. No. 63/396,255 (“The '255 application”) filed on Aug. 9, 2022.

The entire content of the '717, '984 and '255 application is herein incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A READ-ONLY OPTICAL DISC, AS A TEXT FILE OR AN XML FILE VIA THE PATENT

Not applicable.

### STATEMENT REGARDING PRIOR DISCLOSURES BY THE INVENTOR OR A JOINT INVENTOR

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

Not applicable.

### BACKGROUND OF THE INVENTION

Competition is an entity (1) producing results by work from a baseline to a goal benchmark for a reward (5) defined by a law (6) wherein the results: set an original benchmark, are the entities (1) own historical results, are contrasted against another entities (1) results, or any combination thereof; and a judgment from an entity (1) determines which entity (1) receives the reward (5) if applicable. Competitions have existed since biological life forms utilized energy transformation. Organized competitions between humans have existed since before written records. A method of a competition is novel.

An entity (1) is a thing of self existence including a biological life form, an artificial intelligence, a cyborg, or any combination thereof; moreover an entity of the competition includes participants, vendors, witnesses, advisors, and evaluators. An entity (1) may be singular and or plural such as an organization including a union.

Competitions are classified with numerous concepts including: art, science, trivia, business, athletics, racing, socialization, culture, religion, performance, education, hunting, agriculture, politics, career, strategy, production, service, recreation, entertainment, simulation, gaming, gambling, manufacturing, industry, justice, lawsuits, finance, warfare and any combination thereof. Competitions may include puzzles, games, challenges, conflicts, and any combination thereof.

Prior to the disclosed invention, the novelty of utilizing a method of a competition to produce and or administer a competition was unfounded.

Prior to the disclosed invention, the novelty of utilizing a method of a competition including an entity of artificial intelligence as: a participant of the competition, the organization administering the competition, a vendor, an evaluator, a witness, or any combination thereof was unfounded.

Prior to the disclosed invention, the novelty of a method of a competition wherein a strategy for participants to produce results by work towards goals of the competition comprises utilizing a business catalog with the products of vendors with ratings in any medium and accessed locally and or remotely.

Prior to the disclosed invention, the novelty of utilizing a method of a competition to vet a politician from a pool of political candidates comprising a tournament format and or a virtual town hall was unfounded.

Prior to the disclosed invention, the novelty of utilizing a method of a competition for artists to compete (2) in augmented reality and or virtual reality including a tournament format was unfounded.

Prior to the disclosed invention, the novelty of utilizing a method of a competition for artists to compete (2) in augmented reality and or virtual reality including a tournament format for producing holiday decorations was unfounded.

Prior to the disclosed invention, the novelty of utilizing a method of a competition for artists to compete (2) in augmented reality and or virtual reality including a tournament format for producing architecture and or architectural elements was unfounded.

Prior to the disclosed invention, the novelty of utilizing a method of a competition for artists in tournament format wherein the artwork is a medley of modalities and displayed in any medium accessed locally and or remotely was unfounded.

Prior to the disclosed invention, the novelty of utilizing a method of a competition for artists in tournament format wherein the artwork is jewelry was unfounded.

Prior to the disclosed invention, the novelty of utilizing a method of a competition wherein a business catalog with rated services and or the goods of vendors being accessed remotely and or locally is utilized by participants in a medium being audio and or visual as a strategy to produce results by work towards goals of a racing competition was unfounded.

Prior to the disclosed invention, the novelty of utilizing a method of a competition for racing wherein the transports are a medley of classifications including automobiles, watercraft, aircraft, spacecraft, subterranean craft, biological species, and any combination thereof was unfounded.

Prior to the disclosed invention, the novelty of utilizing a method of a competition in a tournament format to produce cinema motion pictures wherein participants are evaluated by their performance in movie clips was unfounded.

Prior to the disclosed invention, the novelty of utilizing a method of a competition to be witnessed on the lunar surface comprising the olympics was unfounded.

Prior to the disclosed invention, the novelty of utilizing a method of a competition for lawsuits (6) was unfounded.

Prior to the disclosed invention, the novelty of utilizing a method of a competition for warfare was unfounded.

Prior to the disclosed invention, the novelty of utilizing a method of a competition for financial organizations was unfounded.

Prior to the disclosed invention, the novelty of utilizing a method of a competition to vet a polymath comprising numerous competition concepts including athletics, educational, art, science and any combination thereof was unfounded.

### BRIEF SUMMARY OF THE INVENTION

The embodiments herein relate generally to the methods of a competition an entity administers including to: plan, operate, adapt, utilize vendor products as goods or services advertised within a business catalog, define laws, form a schedule, configure zones position on environments, display information on a medium for a witness, organize marketing for all entities, plan competition goals for results, organize consultants advising strategy for participants, organize participants competing to produce results by work towards the goals with methods and apparatus, organize feedback from evaluators producing judgements from measurements of the participants results contrasted to the goals, utilize judgements to distribute rewards, proportion awards and penalties to participants with respect to the feedback, eliminate participants according to the law, pause operations, cease operations, and if applicable award prizes acknowledging accomplishments. An entity includes participants, vendors, witnesses, advisors, and evaluators; moreover including artificial intelligence, biological life forms, and hybrids.

The embodiments herein relate generally to the methods of a competition wherein the strategy for the participants includes utilizing a business catalog comprising advertisements from vendors for products with ratings. The products of the vendors include services, goods, or both services and goods which are categorized by their respective classification. The ratings with a custom scale are produced by entities (1) including critics, famous people, celebrities, the general public, artificial intelligence, and any combination thereof. Participants utilize a broker, including artificial intelligence, to negotiate a contract with vendors to utilize their products in exchange for a financial instrument. The participants compete (2) by utilizing the products of the vendors to produce results by working towards the goals of the competition. An evaluator issues feedback to the participants in the form of a judgment made by measuring the results contrasted to the goals and issuing feedback An investor from the organization administering the competition dispenses a reward (5) to the participants proportional to the feedback.

### BRIEF DESCRIPTION OF THE SEVERAL VIEWS OF THE DRAWING(S)

The detailed description of some of the invention is made below with reference to the accompanying FIGS. one and two.

FIG. one is a flow chart.

FIG. two is an art (7) concept of visual art goal.

### DETAILED DESCRIPTION OF THE INVENTION

Competition is an entity (1) producing results from work aspiring from a baseline towards a goal benchmark for a reward (5) defined by a law (6) wherein the results: set an original benchmark, are the entities (1) own historical results, are contrasted against another entities (1) results, or any combination thereof; and a judgment from an entity (1) determines which entity (1) receives the reward (5) if applicable.

Competitions may be complex comprising numerous components including: concepts, organizations, laws (6), participants, environments (4), structures, schedules (3), goals, roles, strategy, apparatus, production, results, measurements, feedback, infographics, reward (5), progression, elimination, witness, and any combination thereof. Competitions may modify components including entering new components, eliminating components, substituting components, and any combination thereof.

Competitions are classified with numerous concepts including: art, science, trivia, business, athletics, races, socialization, culture, religion, performance, education, hunts, agriculture, politics, career, strategy, production, recreation, entertainment, simulation, games, gambles, manufactures, lawsuits, warfares, financials, industry and any combination thereof. Competitions may include puzzles, games, challenges, conflicts, and any combination thereof. Competitions may modify concepts including entering new concepts, eliminating concepts, substituting concepts, and any combination thereof.

Organizations administer a competition by managing and accounting for the operations of the competition. Organizations and or entities may include educational institutions, a government institution, a military, a business including employees and or vendors, a non-profit, a union, an independent contractor, a prisoner, an inpatient, a club, a volunteer, a charity, a religion, an artificial intelligence, or any combination thereof. The organization delegates the commerce of services and goods to an insource, an outsource, and a combination of both. The organization may be centralized, decentralized, or a combination of both. Competitions may modify organizations including entering new organizations, eliminating organizations, substituting organizations, and any combination thereof.

Laws (6) are defined in a clear, concise, and comprehensive manner utilizing rules, regulations, codes, statutes, terms, conditions, and any combination thereof. The law (6) defines all components of a competition including the communication for the expectations regulating the actions of an entity (1) including the enforcement of consequences for not following the law (6). The laws (6) to the competition may be produced and or modified by any entity (1). The organization markets, defines, and records a set of laws (6) for the competition. Competitions may modify laws including producing new laws (6), eliminating laws (6), editing existing laws (6), or any combination thereof.

Entities (1) also known as participants perform in the competition and may include competition between themself, an individual participant versus another individual participant, an individual participant versus a team of participants, a team of participants versus a team of participants, and any combination thereof. Participants may be any type of entity (1) including biological life forms, artificial intelligence, cyborgs, robots, machines, organizations and any combination thereof. Competitions may modify participants including entering new participants, eliminating participants, substituting participants, and any combination thereof.

Environments (4) include an area in space with a unique set of variables including boundaries and conditions. The environment (4) of the competition is substantially demarcated by the laws (6) of the competition. The environment (4) may be physical, virtual, or any combination thereof. The physical environment (4) may be natural, developed, and any combination thereof. The environment (4) may be infinite, definite or any combination thereof. The environment (4) may be extraterrestrial including lunar and martian terrain. The environment (4) may comprise numerous zones including a deontic zone, a cognitive zone, an expressive zone, an aesthetics zone, an administrative zone, a transitional zone and any combination thereof. A deontic zone is for the function including necessity, duty, obligation, and any combination thereof. A cognitive zone is for the function including knowledge, logic, verification, and any combination thereof. An expressive zone is for the function including arts, social institutions, achievements, and any combination thereof. An aesthetics zone is for the function including beauty, taste, the philosophy of art (7) in natural and artificial reference, and any combination thereof. An administrative zone is for the function including legal, authoritative, legislative reference, and any combination thereof. A transitional zone for positioning between numerous other types of zones. A combination zone is for the function including any combination thereof of the above referenced zone. The competition may be modified including producing new environments (4), eliminating environments (4), editing existing environments (4), and any combination thereof.

Structure examples include a landscape, a virtual-scape, an augmented-scape, a cityscape, a reward (5) set, an office space, an archive, a theater, an auditorium, a stadium, a convention center, an arena, a museum, an art (7) gallery, a park, a cruise ship, a campus, a business, a school, a university, a college, a seating area, a prize showcase, an airport, a port, a hospital, a lodge, a resort, a transport, a warehouse, a house, a ward, a dock, a place of worship, a library, a market, a rink, a pit, a pavilion, etc, and any combination thereof. Structures make up a component of the environment. The competition may be modified including producing new structures, eliminating structures, editing existing structures, and any combination thereof.

Schedules (3) are the plan of action over time within an environment (4). Schedules (3) may be long term, mid term, short term, and any combination thereof. Long term schedule (3) examples include once in a lifetime events as well as annual events. Mid term schedule (3) examples may include seasonal, tournament, and daily events. Short term schedule (3) examples may include stages, rounds, legs, and periods. A schedule may have any type of timeframe and is not limited to long, mid, and short term. A schedule may also be determined by some variable other than time including a reward. The schedule (3) may be modified including producing a new schedule (3), eliminating a schedule (3) and editing an existing schedule (3), and any combination thereof.

The periods of a round may be segmented into periods including a welcoming period, an introduction period, a presentation period, a strategy period, a production period, a results period, an evaluation period, and an awards period. The welcoming period is for all entities (1) to convene on the competition. The introduction period is for all entities (1) to be oriented to the competition. The presentation period establishes the competition operations and its respective format. The strategy period is for entities (1) to develop plans of action for winning the competition. The production period implements the actions of the entities (1) for the production of results inspired by the goals of the competition, an evaluation period rewarding (5) results with awards and penalties based on objective and or subjective observations of results contrasted to goals, a results period for announcing the results of the actions produced by the entities (1) working towards the goals of the competition, a conclusion period ceasing operations, and a period for any combination thereof. The rounds and periods may be anywise assembled into the tournament including producing new rounds or periods, eliminating rounds or periods, editing existing periods or rounds, and any combination thereof. Rounds may be scheduled (3) in numerous ways including independent of each other, overlapping, running concurrently, or any combination thereof.

Roles are the responsibility of actions an entity (1) assumes in a certain position which contribute to the operation of the competition. An entity (1) may have one or more roles to assume within a competition. Example roles are administrator, participant, evaluator, and witness. The administrator manages the competition and includes the vendors. The participant competes (2) in the competition by producing results from working towards the goals. The evaluator measures the results of the participants and may reward (5) awards and penalties. The witness views the competition. Refer below to a description of vendors as examples of roles within the competition. The roles of the competition may be modified including producing new roles, eliminating roles, editing existing roles, and any combination thereof.

Goals are the wanted results obtained from the production of work by entities (1) beginning at a baseline and aspiring to finish at a benchmark goal. Goals are defined with measurable results and include process, performance, outcome goals, and any combination thereof. Outcome goals are the desired results of the competition from the actions of the participants in the events. Process goals are the steps of actions towards an outcome goal. Performance goals are the steps of actions towards the process goals. Any entity (1) including a client of the competition may develop goals. The goal of the competition may be modified including producing new goals, eliminating goals, editing existing goals, and any combination thereof.

Apparatus are the resources utilized with a method to produce results by work for competition including: a business catalog, tools, devices, equipment, materials, resources, apparel, accessories etc, and any combination thereof. The apparatus in the competition may be modified including producing new apparatus, eliminating apparatus, altering existing apparatus, and any combination thereof.

Strategy is a plan of action for an entity utilizing a method and apparatus to produce results by work towards goals. Strategy is similar to production wherein the major difference is strategy focuses on planning a course of actions or methods versus the focus of production is the performance of the actions or methods. Strategy relies on estimation and calculation utilizing probability and statistics. A strategy for participants to produce results by work towards goals of the competition comprises utilizing a business catalog with the products of vendors with ratings in any medium accessed locally and or remotely. The strategy of the competition may be modified including producing new strategy, eliminating strategy, editing existing strategy, and any combination thereof.

Production is the performance of creating a result by work of an entity (1) utilizing a method with an apparatus. The components of production include planning, working, inspecting, and adapting. Production organizes methods including identifying problems and setting goals. Work of the goal may be delegated to an entity (1). During the working action of production the entity (1) utilizes methods and apparatus to produce results by work towards the goal with a continuous inspection of the work quality and adapting to any variables. Production relies on accounting for quality control. The production of the competition may be modified including producing new production, eliminating production, editing existing production, and any combination thereof.

Results are produced with work towards the goals of the competition by an entity (1). Examples of results include products, goods, services, scores, grades, elapsed time, profits, votes, artwork, movie clips, time trials, laws (6), scientific theory, casualties, harvests, test scores, data, answers, promotions, wins, emotional responses, financial instruments, property, rulings, rewards, feedback, measurements, property losses, property gains, apparatus, etc, and any combination thereof. The competition may modify results including producing new results, eliminating results, editing results, and any combination thereof.

Measurements are the quantitative unit assignments on a predetermined scale to an observation of the results with reference to a predetermined benchmark. An evaluator may quantify a unit for an observation of the results with respect to an objective benchmark reference and issue a score on a scale to proportion the objective benchmark with the score denoted by a unit. An evaluator may quantify a judgment for an observation of the results with respect to a subjective benchmark reference and issue a grade on a scale to proportion the subjective benchmark with the grade denoted with a mark. Quantifying of measurements include a grade, a score, a ruling, or any combination thereof. An evaluator may be an entity, a judge, a jury, a witness, a connoisseur, an appraiser, a referee, an umpire, an artificial intelligence, a critic, an interviewer, an investigator, or any combination thereof. The competition may modify measurements including producing new measurements, eliminating measurements, editing measurements, and any combination thereof.

Feedback is the constructive and or deconstructive criticism by an entity (1) in reference to the production of results from the work of an entity (1) which may have positive or negative consequences. Feedback may be given before production, during production, after production, or any combination thereof. Feedback may come from an entity (1) including a witness, a consultant, a recorder, a critic, an evaluator, an artificial intelligence, and any combination thereof. The feedback may be in the form of measurements on a scale as a score, a grade, a ruling, a rating or any combination thereof from an evaluator which enables the progression of a competition. If there is more than one evaluator there may be an average or a total from the feedback. The competition may modify feedback including producing new feedback, eliminating feedback, editing feedback, and any combination thereof.

Infographics are the display of information referencing the competition. The information may include: names of entities, the law (6), the score, the grade, the ruling, the rating, a historical data, the time, a map, a biometric data, a compiled data, a scoreboard, a schedule (3), a pamphlet, the goals, a demographic, a license, an instruction, an inventory, a business catalog, a roster, a motivational quote, a hall of fame, a product, a measurement, etc, or any combination thereof. The competition may modify the infographics including producing new infographics, eliminating infographics, editing infographics, and any combination thereof.

Rewards (5) of the competition include awards, penalties, and any combination thereof. Awards include a score increase, a grade of increased value, a ruling in favor, a tangible property gain, an increased rating, a prize, an acknowledgement, an intangible property gain, a service, a good, issuing a financial instrument, a time increase, an entertainment, a zone, a motivation, an immunity, an authority, a knowledge, a rest, a progression in the competition, or any combination thereof. Penalties include a score decrease, a grade of decreased value, a ruling against, a tangible property loss, an intangible property loss, a property loss, a discontinued service, a loss of goods, revoking a financial instrument, a time decrease, a boredom, a zone loss, a demotivation, a liability increase, a demotion, a confusion, a fatigue, an elimination, and any combination thereof. In certain circumstances an award is equivalent to a penalty such as when the object of a competition is to receive the lowest score thus the reward (5) of an award would be a score decrease instead of an increase. The competition may modify the rewards (5) including producing a new reward (5), eliminating a reward (5), editing a reward (5), and or any combination thereof.

Financial instruments are monetary contracts between at least two entities (1) which legally produce, define, and administer the rights and responsibilities of the entities (1). Tangible property is anything with value derived with respect to its matter including both real property and personal property. Intangible property is anything with value derived with minimal respect to its matter including intellectual property and trade secrets. The tangible and intangible monetary forms include banknotes, coin, currency, cryptocurrency, non fungible tokens, bonds, loans, stocks, options, futures, securities, credit, debt, and any combination thereof. For purposes of this competition the term financial instruments will include financial instruments, tangible property, intangible property, and or any combination thereof. The competition may modify financial instruments including producing new financial instruments, eliminating financial instruments, editing financial instruments, and any combination thereof.

Progression of the competition may comprise numerous elimination formats including: progressive elimination, single elimination, double elimination, triple elimination, a free for all, round robins, a repechage, a best of a series, a step ladder format, a pot system, and any combination thereof. The competition may modify the elimination format including producing a new elimination format, eliminating a elimination format, and editing a elimination format, and or any combination thereof.

Elimination of entities (1) may be for any reason and at any time including: violating the law (6), losing by elimination, forfeiture, etc including any combination thereof. In certain competition formats, a notice of stay for a participant may be issued for a participant which is being eliminated in order to save them from elimination. The competition may modify the elimination reasons including producing a new elimination reason, eliminating an elimination reason, editing an elimination reason and any combination thereof.

The competition can be determined by any type of variable including time however it may also be determined by any type of variable such as a score. The competition may be ongoing as in a free for all or have a definitive ending as in a single elimination tournament or any combination thereof. The competition may modify the variable including producing a new variable, eliminating an variable, editing an variable and any combination thereof.

The competition may have numerous entities (1) receiving rewards (5) including places of the competition comprising first place, second place, third place, etc. In contrast the competition may be a winner takes all rewards (5). The competition may modify the places including producing a new place, eliminating an place, editing a place and any combination thereof.

Witness of the competition may be live or recorded on a medium as a form of media and presented to a witness entity (1) publicly, privately, or any combination thereof. The medium may have components comprising a visual component, an auditory component, a somatosensory component, a proprioception component, an olfactory component, and any combination thereof. The competition may modify the medium including producing a new medium, eliminating a medium, editing a medium, and any combination thereof. The media may be accessed live, post production, or any combination thereof. The witness of the competition may be composed into a single episode, a series of episodes, or any combination thereof. Forms of media comprise a written publication, a television program, an online website, an internet, an intranet, a network, a local network, a space network, a satellite (26) network, a computer application, streaming, a social media, an augmented reality, a virtual reality, a hotspot, a bluetooth, a broadcast, a waveform, and any combination thereof. The competition may modify the media including producing a new media, eliminating a media, editing a media, and any combination thereof. The competition may modify the witness including producing a new witness, eliminating a witness, editing a witness, and any combination thereof.

Vendors are entities (1) offering products as goods and services in exchange for a financial instrument. The following are examples of the types of vendors available in the competition including but not limited to: an investor provides a financial instrument in exchange for an interest in a business or a return of a financial instrument with greater value; a lender provides capital in exchange for a future return of the capital with interest; a banker provides verification for deposits and withdrawals of financial instruments; an insurance agent provides financial security for damage, and or losses; an accountant provides the measuring, operating, and communicating of finances segmented into public, private, and tax accounting; a client provides a demand within a market; a marketer provides the administration of the market for services and goods including research, design, pricing, advertising, warranties, embedded placements, and branding; a lawyer (6) provides representation and practice in all matters of the law (6) including legislation, cases, and contracts; a union organization provides assertion for a group of entities (1) coordinating for wages, working conditions, promotions, and branding; an agent provides representation of employees for employers; a manager administers employees; a supplier provides goods for a consumer; an evaluator provides the judgement of observations; a critic provides a rating and opinion on a product and or service of a vendor; a dealer provides for the purchasing of goods and or services; an auctioneer provides the pace for the selling of goods and or services; an owner of property provides goods in exchange for capital for a set period of time; a transporter provides for the movement of entities (1), goods, and or services; a courier provides for the receiving and delivering of parcels; a pilot provides the operation of aircraft to transport entities (1) and or cargo in the air; a captain provides for the operation of watercraft to transport entities (1) and or cargo in water; a driver provides the operation of automobiles to transport entities (1) and cargo on land; a general contractor provides the administration of construction utilizing subcontractors including: plumbers, electricians, H.V.A.C. technician, etc; a castor provides the formation of objects in molds; a welder provides the construction of metal structures and or joins metal together; a forger provides for the formation and or melding of metal; a miner provides for the extraction of materials out of the terrain; a manufacturer provides the production of goods from methods, apparatus, and materials; a woodworker provides goods made from wood; a mechanic provides the construction, maintenance, and repair of an apparatus especially a machine; a security officer provides protection from risks including criminals; a rancher provides for raising livestock; a butcher provides for the harvesting and processing of livestock; a farmer provides for the growing of plants and harvesting; a food processor provides for the packaging and handling of plants and livestock; a grocer provides for the storage and sale of processed plants and livestock; an upholster provides for the production of furniture; a locksmith provides and or breaks locks; a computer architect provides the production of technology; an engineer provides design, analyzation, construction, and testing of methods, apparatus, and materials; a communicator provides the exchange of meaning through: visual images including writing, auditory means including speaking, electromagnetic means, and or biochemical means, which includes narrators, announcers, and dispatchers, etc; a telecommunications network provides an exchange of communication between something and somewhere; a scientist provides research to expand intelligence; a zookeeper provides caretaking of animals in captivity; a designer provides plans for methods, apparatus, and materials; a tailor provides for the production of clothing; a jeweler provides for the production of jewelry; a meteorologist provides research and communication advisories on the weather; a writer provides written communications; a journalist provides conducting interviews and researching topics to produce media; an artist provides producing creative work in numerous mediums; a framer provides frames for art; a bag maker provides for the production of luggage; a toymaker provides for the production of apparatus for children to utilize for play; a performer provides entertainment; a cosmetologist provides beauty treatments; a musician provides auditory performances and recordings for entertainment; a guide provides escorts for tourists through settings; a bookie provides the design of the terms for wagers to agree upon for collection or pay off; a host provides hospitality to guests and visitors; a chef provides the preparation of food for consumption; a mixologist provides the preparation of drinks for consumption; a gamester provides access to all things games; an audience provides motivation and discouragement; a criminal provides breaking the laws (6); a socialite provides mingling with guests and visitors; a librarian provides a keeping and distributing of information from references; an archiver provides for the administration of the storage of things; a curator provides a keeping for the collection of things; an educator provides instruction on specific subjects to improve knowledge; a philanthropist provides private services and goods for the good of the public; a religious leader is an organization for providing spiritual services and culture; a utility administrator provides water, electricity, fuels and or waste removal; a firefighter provides fighting fire; a police officer provides law (6) enforcement and protection; a medic, nurse and doctor provides first aid and healthcare; a janitor provides for the cleaning and removal of waste; a government provides an organization administering public service for the good of the public; an artificial intelligence provides or has the ability to provide any of the former vendor services and or goods. The competition may modify the vendors including producing a new vendor, eliminating an vendor, editing an vendor and any combination thereof.

Best use for a schedule (3) and witness of a competition is formulated as an entertainment series with a goal of 16 or more competition rounds and corresponding episodes for witness. The entertainment series episodes have a goal of 60 minutes of show time with commercials for advertisements included. An outline of the competition episodes in a season will include, but is not limited to: an introduction round to the competition episode including a synopsis, a qualifier competition, interviews, screenings, and selection of participants; numerous intermediate round episodes of the competition with a production period for producing goals created by a client and an elimination period to reduce the number of participants in the competition; the competition finale round episode declaring the winner; and the award round episode with the grand prize awarded in a ceremony with reviews from witness and the organization and behind the scenes with bloopers.

Best use strategy by participants utilize a business catalog comprising advertisements from vendors for products with ratings. The products of the vendors include services, goods, or both services and goods which are categorized by their respective classification. The ratings with a custom scale are produced by entities (1), critics, famous people, celebrities, the general public, artificial intelligence, and any combination thereof. The scales include stars, numerical values, thumbs up or down, yes or no, alphabetical grades, etc, and any combination thereof. The competition may modify the scales including producing a new scale, eliminating a scale, editing a scale and any combination thereof. The participants compete (2) by utilizing the products of the vendors to produce results by work towards the goals of the competition. An evaluator issues feedback to the participants in the form of a judgment made by measuring the results contrasted to the goals and issuing a reward. An investor from the organization administering the competition dispenses a reward (5), including a financial instrument, to the participants proportional to the reward. The competition may modify the reward (5) including producing a new reward (5), eliminating a reward (5), editing an existing reward (5), and any combination thereof. Participants utilize a broker to negotiate a contract with the vendors for their products in exchange for a financial instrument as a strategy to win the competition. The business catalog may be displayed on any type of medium available including tangible or intangible mediums. The business catalog may be centralized, decentralized, or a combination of both. The entities including the participants, vendors, and brokers access the business catalog in locally, remotely, or a combination of both. The competition may modify the business catalog including producing a new business catalog, eliminating a business catalog, editing an existing business catalog, and any combination thereof.

Best use method of an art competition comprises artists producing artwork with art apparatus predominately in an art studio to exhibit at an art gallery for judgment by an evaluator, or connoisseur, as a grade to compare and decide who is eliminated and who wins. In the competition a client produces goals for the participants to produce visual art (7) projects utilizing art goods and performing an art (7) service. The competition is a chance for artists to win a reward (5) of a grand prize for the right to compose an art museum exhibit with a grand opening ceremony including live entertainment, food and drinks, and an art auction with a portion of the proceeds rewarded (5) to the artist and a charity of their choice. At least annually an organization such as a non profit business working in collaboration with a charity organization administers the art competition for a return including supporting the arts, creating opportunity for participants, advertising for select vendors, and the entertainment of the general public. The ultimate outcome goal for the organization is to produce an art olympics which may coincide with the winter olympics; with the concept of the olympics in mind the art competition can be scaled and reformatted for micro and macro qualifier competitions. The competition may encounter numerous environments (4) including virtual space, art studios, art museums, an archive for storage, a theater, a park, landscapes, cityscapes, plazas, etc, and any combination thereof. Each round, the organization in collaboration with a client produces a visual art (7) project to inspire the participants to produce artwork utilizing the business catalog and performing an art (7) service. The business catalog of vendors can be produced as a goal by the client for the artists to make their own custom catalog in the medium and style of their preference. The artwork produced by the participants is exhibited in place or a curator places the art (7) within an art exhibit at a gallery. An evaluator or appraiser along with a client, an ambassador, and a witness produce feedback of the artwork as a grade rewarded (5) to the artist from a judgment measured with respect to a subjective reference. The artists with the failing grades compete (2) in a head to head challenge and the loser is eliminated from the competition in a progressive elimination structure and the remaining participants continue to the next round. At the finale round three artists compete (2) against each other to win the competition. The winner of the competition manages the grand opening for an art gallery exhibit including delegating projects to the artists from the competition. The entire competition will be recorded and produced into a medium as entertainment for witness. As an example a client produces a visual art (7) project for participants to produce a trademark logo (8) with the requirements for the project to be in a trademark fanciful (9) style and to be complete with a trademark symbol (10).

Best use method of a racing competition comprises operators producing time trials with transports predominately at a racetrack for judgment by a racetrack marshal. In the competition the client produces goals for participants to modify their transports and orient to a racetrack. The competition comprises the chance for operators to win a reward (5) for a grand prize of a champagne celebration rally, the right to join a professional racing team with sponsors, a vehicle, apparel, and a home track. The competition comprises a medley of transports for racing comprising for example automobiles, watercraft, aircraft, spacecraft, subterranean craft, biological species, and any combination thereof. Racing may be biologically powered, environment powered, petroleum powered, electrically powered, accumulator powered and any combination thereof. An organization including an automotive manufacturer collaborating with a racing circuit administers the competition annually for a return including advertising for vendors, vetting racing talent, and the entertainment of the general public. The competition encounters numerous environments (4) including a racetrack, a mechanic shop, distributor showcases, a box office, etc, and any combination thereof. The competition is recorded and displayed for a witness in numerous media mediums. Each round racers will make modifications to their primary transportation device, purchase equipment, recruit team members, and practice, etc. A round robin tournament style determines seeding into the next round and also disqualifies racers from winning the competition in certain circumstances.

Best use method of a cinema competition comprises actor participants to produce movie scene clips of a motion picture screenplay for the chance to win the reward (5) of a grand prize comprising the right to co-direct a motion picture, a trailer production, screening event for the opening night premiere of the movie at a theater, concessions, and a red carpet entrance. The organization can be a university working in collaboration with an entertainment company for the return of vetting actors, creating exposure opportunities for participants, and the entertainment of the general public. At least annually the competition conducts operations at numerous environments (4) comprising working on set at a movie studio, editing film at a business office, and viewing media at a movie theater. The organization in collaboration with a client produces goals for a movie clip project for the actors to produce performances in the movie. The movie clip projects may all originate from the same single screenplay. Participants can rotate work positions for producing the movie scene clip operations including directing, producing, script editing, casting, rehearsing, scene takes, prop manufacturing, costume design, staging, sound bits, green screens, cinematography, etc, or any combination thereof. Participants utilize the business catalog as strategy to win the competition. An evaluator or celebrity critic along with an ambassador, the client, and a witness will judge each participants performance with respect to a subjective reference and reward (5) them with a grade and the participants with the inferior grades are up for elimination. Participants are eliminated in a progressive elimination structure where at least one actor is eliminated per episode with rare exception. The finale episode is the climatic movie scene clip project performance released at the end of the premier. The winning actor starts over shooting the movie by directing and producing the movie screenplay from start to finish including coordination of casting, editing the script, costume selections, stage designs, cinematography, lighting, editing scenes, etc, and any combination thereof.

Best use method of a political competition comprising the concept of a reality show for candidate participants to produce a leadership reputation for the chance to win a grand prize of a political contribution, a touring package, billboard selfies, assistance with filling for office, and a rally event with food and drinks, festivities, and an awards ceremony for the participants. Sample political offices include “president,” congressman, governor, mayor, judge, commissioner, county manager, sheriff, etc. At least annually an organization such as a for political action committee working in collaboration with a political organization administers the political competition for a return including vetting political candidates, educating the public about patriotism, advertising for select vendors, and the entertainment of the general public. The competition encounters numerous environments (4) including a soap box, a town hall, a court facade, the country club, a campus, touring districts, amphitheater's, conventions, and the pit. Each round the organization in collaboration with a client produces a public service operation project to inspire the participants to produce a reputation of leadership utilizing the business catalog. Participants utilize the business catalog as strategy to win the competition. Public service operations include an aptitude test with a physical, market research, developing a political platform, drafting a speech, touring the district to meet the voters, developing community partnerships, raising capital and contract review, planning strategy and logistics, recruiting members of the public to voter registration, community service, promotional and advertising production, orienting to office, writing to incumbents, identifying community problems and proposing solutions, etc, and any combination thereof. The organization will put it to a vote and the grade awarded to the candidate is proportional to the votes received. 33% of the vote is from the organization, 33% of the vote is from randomly selected members of the public recruited by a marketing campaign and 33% of the vote is from all the starting participants, 1% of the vote is a silver dollar in the event of a tie. The two candidates with the lowest vote count will enter a no holds barred smear campaign challenge and voted on by the remaining candidates, also known as the electoral college recount. A veto may be issued to save a participant. Participants eliminated from the competition may choose to continue with their campaign created during the competition independent of the organization as a consolation prize. The finale episode is a political debate between three participants.

Best use of a business competition comprising the concept of a reality role for entrepreneur participants to produce returns for the chance to win a reward (5) of a grand prize comprising a ribbon cutting celebration for the grand opening of a business with a scale investment donation from the organization, awarding a marketing package with presentation, and a flash mob networking event with live entertainment, food and drinks, festivities, and an awards ceremony for the participants. The organization can be a for profit business working in collaboration with a charity for the return of educating future entrepreneurs on business startup and operation, creating opportunity for participants, advertising for vendors, and the entertainment of the general public. Sample business classifications include, online video platforms, phone applications, food products, cosmetics, drinks, restaurants, catering, mobile food trucks, suppliers, transportation, guides, influencers, entertainment, retail, fashion, boutiques, services, trades, industry, manufacturing, consulting, delivery, etc. At least annually the competition conducts operations at numerous environments (4) comprising working at commercial facilities, warehouses, retail space, and corporate headquarters. The organization in collaboration with a client produces an outcome goal for a business operation project for the entrepreneurs to produce results working towards a financial instrument. Business operations include market research, developing business plans, drafting a pitch, obtaining licenses and insurance, developing product and intellectual property, raising capital and contract review, leasing working space, acquiring inventory, hiring personnel, promotional and advertising production, production of products, sales and sales events, performance review and adaptation strategy, maintaining operations, scaling operations, etc. As an example a client produces an outcome goal for participants to produce an intellectual property of a trademark logo (8) with the requirements for the style to be a trademark fanciful (9) and to be complete with a trademark symbol (10). Participants utilize the catalog as strategy to win the competition. The financial instruments are recorded by a bookkeeper for evaluation in a board meeting to reward (5) a score to the entrepreneur. An evaluator will judge the entrepreneur with respect to an observation and issue a reward (5). The rewards (5) are combined and a banker exchanges a financial instrument to the entrepreneur for the results. The business competition's best method of elimination is a combination of stages in a tournament style. Stage one is a free for all with four rounds and no eliminations. Stage two is one round where participants are seeded into a bracket by their total rewards (5) and half of the participants with the lowest returns are eliminated. Stage three is back to the free for all with four rounds and no eliminations. Stage four is one round where participants are again seeded into a bracket and half of the participants with the lowest returns are eliminated. Stage five again is a free for all for four rounds with no eliminations. Stage six participants are seeded into a bracket by their total reward (5) and half of the participants with the lowest returns are eliminated. Stage seven is the finale series between two participants for the best two out of three rounds. Participants eliminated from the competition may choose to continue with their business created during the competition independent of the organization as a consolation prize.

Best use combination competition includes numerous concepts combined to form a polymath competition.

### SEQUENCE LISTING

Not applicable.

1. A method of a competition comprising:
providing an entity;
forming an organization with said entity;
administering said competition by said organization;
defining a role to said entity;
delegating said role to said entity;
setting a goal;
legislating a law;
planning a concept;
implementing said concept;
assembling a schedule;
effecting said schedule;
planning an environment;
building said environment;
marketing said competition;
adapting to a variable;
drafting a participant;
organizing a witness;
presenting said law;
devising a strategy;
providing said apparatus;
utilizing an apparatus;
competing by a work with said apparatus;
producing a result by said work;
judging a measurement of said result by said evaluator with reference to said goal;
quantifying said measurement;
utilizing said measurement producing a feedback;
providing a reward proportional to said feedback;
announcing said reward;
providing an infographic; and
repeating any of an action as needed in any order for said competition.

2. The method of claim 1, further comprising eliminating said participant with an elimination method according to said law.

3. The method of a competition of claim 2, further comprising declaring a finish to said competition comprising a winner said participant and a place of said participant.

4. The method of a competition of claim 3, further comprising:
recording said competition on a medium; and
displaying said medium for said witness via a media.

5. The method of a competition of claim 4, wherein said strategy comprises:
producing a business catalog comprising a vendor;
advertising a product of said vendor in said business catalog;
negotiating a contract between said participant and said vendor to exchange said reward for said product; and
utilizing said product by said participant for said work.

6. The method of a competition of claim 5, further comprising:
valuing said product with a rating on a scale; and
determining said rating by said entity.

7. The method of claim 1, further comprising declaring a finish to said competition comprising a winner said participant and a place of said participant.

8. The method of claim 7, further comprising:
recording said competition on a medium; and
displaying said medium for said witness via a media.

9. The method of a competition of claim 8, wherein said strategy comprises:
producing a business catalog comprising a vendor;
advertising a product of said vendor in said business catalog;
negotiating a contract between said participant and said vendor to exchange said reward for said product; and
utilizing said product by said participant for said work.

10. The method of a competition of claim 9, further comprising:
valuing said product with a rating on a scale; and
determining said rating by said entity.

11. The method of a competition of claim 1, further comprising:
recording said competition on a medium; and
displaying said medium for said witness via a media.

12. The method of a competition of claim 11, wherein said strategy comprises:
producing a business catalog comprising a vendor;
advertising a product of said vendor in said business catalog;
negotiating a contract between said participant and said vendor to exchange said reward for said product; and
utilizing said product by said participant for said work.

13. The method of a competition of claim 12, further comprising:
valuing said product with a rating on a scale; and
determining said rating by said entity.

14. The method of a competition of claim 1, wherein said strategy comprises:
producing a business catalog comprising a vendor;
advertising a product of said vendor in said business catalog;
negotiating a contract between said participant and said vendor to exchange said reward for said product; and
utilizing said product by said participant for said work.

15. The method of a competition of claim 14, further comprising:
valuing said product with a rating on a scale; and
determining said rating by said entity.

16. The method of a competition of claim 1, further comprising:
providing a pro se non provisional patent;
requesting an examiner to author one of a claim for the invention titled method of a competition; and
wherein said examiner writing said claim completes said pro se non provisional patent.
